(19) United States
(12) Patent Application Publication
(10) Pub. No.: US 2011/0143693 A1
(43) Pub. Date: Jun. 16, 2011

(54) INFORMATION PROCESSING APPARATUS

(75) Inventor: Toshiyuki Masaki, Fukaya-shi (JP)

(73) Assignee: KABUSHIKI KAISHA TOSHIBA, Tokyo (JP)

(21) Appl. No.: 12/960,234

(22) Filed: Dec. 3, 2010

(30) Foreign Application Priority Data
Dec. 16, 2009 (JP) 2009-285427

(51) Int. Cl. H04W 88/02

(52) U.S. Cl. 455/90.3

(57) ABSTRACT

An information processing apparatus includes a first wireless communication module, a first antenna, a second wireless communication module, a second antenna, a filter circuit and a control module. The first wireless communication module is configured to wirelessly transmit and wirelessly receive signals by using a first frequency band. The first antenna is coupled to the first wireless communication module. The second wireless communication module is configured to wirelessly transmit and wirelessly receive signals by using a second frequency band. The second antenna is coupled to the second wireless communication module. The filter circuit is connected between the second wireless communication module and the second antenna and is configured to attenuate a signal belonging to the first frequency band. The control module is configured to turn on the filter circuit when the first wireless communication module is in an operative state.

### CROSS-REFERENCE TO RELATED APPLICATIONS

This application is based upon and claims the benefit of priority from Japanese Patent Application No. 2009-285427, filed Dec. 16, 2009; the entire contents of which are incorporated herein by reference.

### FIELD

Embodiments described herein relate generally to an information processing apparatus, such as a personal computer, which includes an antenna.

### BACKGROUND

In recent years, various kinds of portable personal computers, such as a notebook personal computer, have been developed. Most of these kinds of personal computers have a wireless communication function which enables execution of wireless communication with an external device, such as a server on the Internet, in a mobile environment.

In addition, recently, with an increase in number of kinds of wireless communication systems which are usable, the portable personal computer often includes a plurality of wireless communication modules. In this case, a plurality of antennas are often disposed, which correspond to the respective wireless communication modules, within the housing of the portable personal computer.

However, since the housing of the portable personal computer is relatively small, it may be difficult to secure an adequate distance between the antennas. Consequently, the isolation characteristics between the antennas tend to easily deteriorate, leading to easy occurrence of radio wave interference. In particular, in the case where frequency bands, which are respectively used by the wireless communication modules in the computer, are neighboring or overlapping each other, the influence of radio wave interference may become conspicuous and the throughput characteristics of wireless communication, for instance, may greatly deteriorate.

Jpn. Pat. Appin. KOKAI Publication No. 2004-363728 discloses an apparatus including a first wireless communication module and a second wireless communication module. In order to prevent an interference of communication between the first wireless communication module and second wireless communication module, this apparatus has a function of lowering the transmission output level of the first wireless communication module.

However, with this structure in which the transmission output level of the first wireless communication module is lowered, it is possible that the range of communication of the first wireless communication module may greatly be narrowed.

### BRIEF DESCRIPTION OF THE DRAWINGS

A general architecture that implements the various features of the embodiments will now be described with reference to the drawings. The drawings and the associated descriptions are provided to illustrate the embodiments and not to limit the scope of the invention.

FIG. 1 is an exemplary perspective view illustrating the external appearance of an information processing apparatus according to an embodiment;

FIG. 2 is an exemplary block diagram illustrating the system configuration of the information processing apparatus of the embodiment;

FIG. 3 is an exemplary graph showing an example of isolation characteristics between antennas;

FIG. 4 is an exemplary graph showing an example of frequency characteristics of a filter circuit which is provided in the information processing apparatus of the embodiment;

FIG. 5 is an exemplary graph showing an example of isolation characteristics between antennas, which are improved by the filter circuit shown in FIG. 4; and

FIG. 6 is an exemplary flow chart illustrating the procedure of a wireless communication module control process which is executed by the information processing apparatus of the embodiment.

### DETAILED DESCRIPTION

Various embodiments will be described hereinafter with reference to the accompanying drawings.

In general, according to one embodiment, an information processing apparatus comprises a first wireless communication module, a first antenna, a second wireless communication module, a second antenna, a filter circuit and a control module. The first wireless communication module is configured to wirelessly transmit and wirelessly receive signals by using a first frequency band. The first antenna is coupled to the first wireless communication module. The second wireless communication module is configured to wirelessly transmit and wirelessly receive signals by using a second frequency band. The second antenna is coupled to the second wireless communication module. The filter circuit is connected between the second wireless communication module and the second antenna and is configured to attenuate a signal belonging to the first frequency band. The control module is configured to turn on the filter circuit when the first wireless communication module is in an operative state.

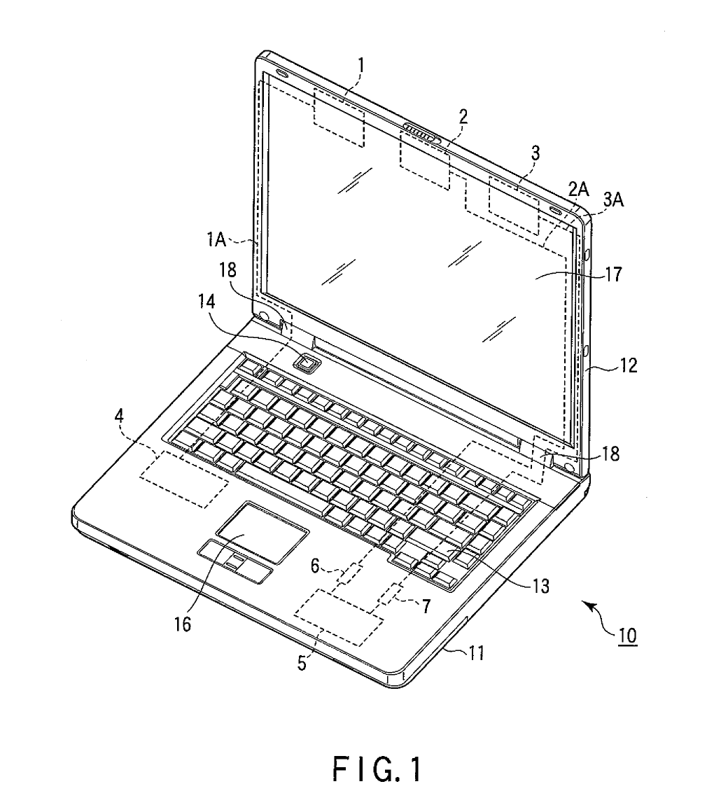

FIG. 1 shows the external appearance of an information processing apparatus according to an embodiment. The information processing apparatus is realized, for example, as a battery-powerable portable personal computer 10.

FIG. 1 is a perspective view of the computer 10 in the state in which a display unit of the computer 10 is opened. The computer 10 comprises a computer main body 11 and a display unit 12. A display device, which is composed of a liquid crystal display (LCD) 17, is built in the display unit 12. The display screen of the LCD 17 is disposed on an approximately central part of the display unit 12.

The display unit 12 is rotatably attached to the computer main body 11 via a hinge portion 18. The hinge portion 18 is a coupling module which couples the display unit 12 to the computer main body 11. Specifically, the display unit 12 is supported by the hinge portion 18 which is disposed on a rear end portion of the computer main body 11. The display unit 12 is attached to the computer main body 11 via the hinge portion 18 so as to be rotatable between an open position where the top surface of the computer main body 11 is exposed and a closed position where the top surface of the computer main body 11 is covered with the display unit 12.

In the display unit 12, a plurality of antennas are provided. FIG. 1 shows an example of the structure in which three antennas 1, 2 and 3 are provided within the display unit 12. The antenna 1 is used, for example, by a first wireless communication module 4 in the computer main body 11. The antenna 1 is coupled to the first wireless communication module 4 via a feeder line 1A. The feeder line 1A can be realized by, for example, a coaxial cable. The other two antennas 2 and 3 are used, for example, by a second wireless communication module 5 in the computer main body 11. The two antennas 2 and 3 are used in order to realize a diversity function. The antennas 2 and 3 are coupled to the second wireless communication module 5 via feeder lines 2A and 3A. Each of the feeder lines 2A and 3A can be realized by, for example, a coaxial cable. The antennas 1, 2 and 3 are disposed, for example, at an upper end portion within the display unit 12. By disposing the antennas 1, 2 and 3 at the upper end portion within the display unit 12, the wireless communication modules 4 and 5 can execute wireless communication with external devices in the state in which the antennas 1, 2 and 3 are disposed at a relatively high position.

The computer main body 11 is a base unit having a thin box-shaped housing. A keyboard 13, a power button 14 for powering on/off the computer 10 and a touch pad 16 are disposed on the top surface of the computer main body 11. In the computer main body 11, there is provided a system board (also referred to as “motherboard”) on which various electronic components are disposed. The above-described first wireless communication module 4 and second wireless communication module 5 are provided on the system board. The first wireless communication module 4 is configured to execute wireless communication according to a first wireless communication system. The second wireless communication module 5 is configured to execute wireless communication according to a second wireless communication system.

The distance between the antenna 1 and the antenna 2, 3 is relatively short. Thus, the isolation level between the antenna 1 and the antenna 2, 3 is not adequate, and a radio wave interference tends to easily occur. In particular, in the case where the frequency band, which is used by the first wireless communication module 4, and the frequency band, which is used by the second wireless communication module 5, are neighboring or overlapping each other, it is possible that the influence of the radio wave interference between the first wireless communication module 4 and second wireless communication module 5 becomes conspicuous. For example, radio waves radiated from the antenna 1 (i.e. a transmission signal from the first wireless communication module 4) may possibly be input to the second wireless communication module 5 via the antenna 2 or 3. In usual cases, in a reception circuit module within the second wireless communication module 5, signals with frequencies, other than a desired signal frequency, are attenuated to some degree. However, since the isolation level between the antenna 1 and the antenna 2, 3 is low, it is possibly that the level of the signal, which is input from the antenna 1 to the second wireless communication module 5, is considerably higher than the level of the desired signal. In this case, deterioration occurs in the throughput characteristics of the second wireless communication module 5. In particular, in the environment in which the reception signal level of the second wireless communication module 5 is relatively low, it is possible that the throughput characteristics of the second wireless communication module 5 are greatly deteriorated.

In the present embodiment, filter circuits 6 and 7 are provided in order to prevent degradation in throughput characteristics due to a radio wave interference. The filter circuit 6 is connected between the second wireless communication module 5 and the antenna 2, and the filter circuit 7 is connected between the second wireless communication module 5 and the antenna 3. Each of the filter circuits 6 and 7 is a filter for attenuating a signal in the frequency band that is used by the first wireless communication module 4. For example, in the case where the first wireless communication module 4 is configured to wirelessly transmit and wirelessly receive signals by using a first frequency band and the second wireless communication module 5 is configured to wirelessly transmit and wirelessly receive signals by using a second frequency band, the filter circuits 6 and 7 may be realized by filters which attenuate a signal belonging to the first frequency band.

In the embodiment, each of the filter circuits 6 and 7 is turned on/off, according to whether the first wireless communication module 4 is in an operative state or in an inoperative state. For example, when the first wireless communication module 4 is in the operative state, each of the filter circuits 6 and 7 is turned on. Thereby, the signal which is input from the antenna 1 to the antenna 2, 3, that is, a transmission signal from the first wireless communication module 4 which is input to the antenna 2, 3, is attenuated by the filter circuit 6, 7, and then the attenuated signal is sent to the second wireless communication module 5.

As a result, the level of the transmission signal from the first wireless communication module 4, which is input to the second wireless communication module 5, can be lowered by, e.g. about 10 dB. In other words, it is possible to obtain the same advantageous effect as in the case where the isolation level between the antenna 1 and the antenna 2, 3 is improved by about 10 dB, without varying the physical distance between the antenna 1 and the antenna 2, 3. Thus, the deterioration in throughput characteristics due to a radio wave interference can be alleviated.

On the other hand, when the first wireless communication module 4 is in the inoperative state, each of the filter circuits 6 and 7 is turned off. Thereby, since the filter circuits 6 and 7 are cut off from the feeder lines 2A and 3A, the signal, which is input to the antenna 2, 3, bypasses the filter circuit 6, 7, and is directly sent to the second wireless communication module 5. Therefore, the filter circuits 6 and 7 do not affect the characteristics of the antennas 2 and 3, or the impedances of the feeder lines 2A and 3A.

The filter circuits 6 and 7 are provided not in the display unit 12, but in the main body 11. This aims at decreasing, as short as possible, the distance between each of the filter circuits 6 and 7 and the second wireless communication module 5. Hence, the filter circuit 6, 7 can also function to prevent a radio-frequency signal, such as noise, from entering the second wireless communication module 5 via the feeder line 2A, 3A.

As has been described above, a radio wave interference may occur when the first frequency band, which is covered by the antenna 1, and the second frequency band, which is covered by the antenna 2, 3, are neighboring. In the case where each of the antennas 2 and 3 is configured to cover the first frequency band and second frequency band, the susceptivity to the influence of the radio wave interference would become higher. The reason for this is that the transmission signal from the first wireless communication module 4 (the signal radiated from the antenna 1) more easily enters the second wireless communication module 5 via the antenna 2, 3.

For example, the computer 10 may adopt such a structure that the computer 10 further includes a third wireless communication module which wirelessly transmits and wirelessly receives signals by using the first frequency band. In this case, such a structure may be adopted that each of the antennas 2 and 3 is shared by the second wireless communication module 5 and the third wireless communication module. Each of the antennas 2 and 3 is composed of a wide-band antenna which covers the first frequency band and second frequency band. In addition, not only the second wireless communication module 5 but also the third wireless communication module is coupled to each of the antennas 2 and 3. Specifically, the second wireless communication module 5 and the third wireless communication module are coupled to the feeder line 2A that is connected to the antenna 2. Further, the filter circuit 6 is also connected to the feeder line 2A. Similarly, the second wireless communication module 5 and the third wireless communication module are coupled to the feeder line 3A that is connected to the antenna 3. Further, the filter circuit 7 is also connected to the feeder line 3A.

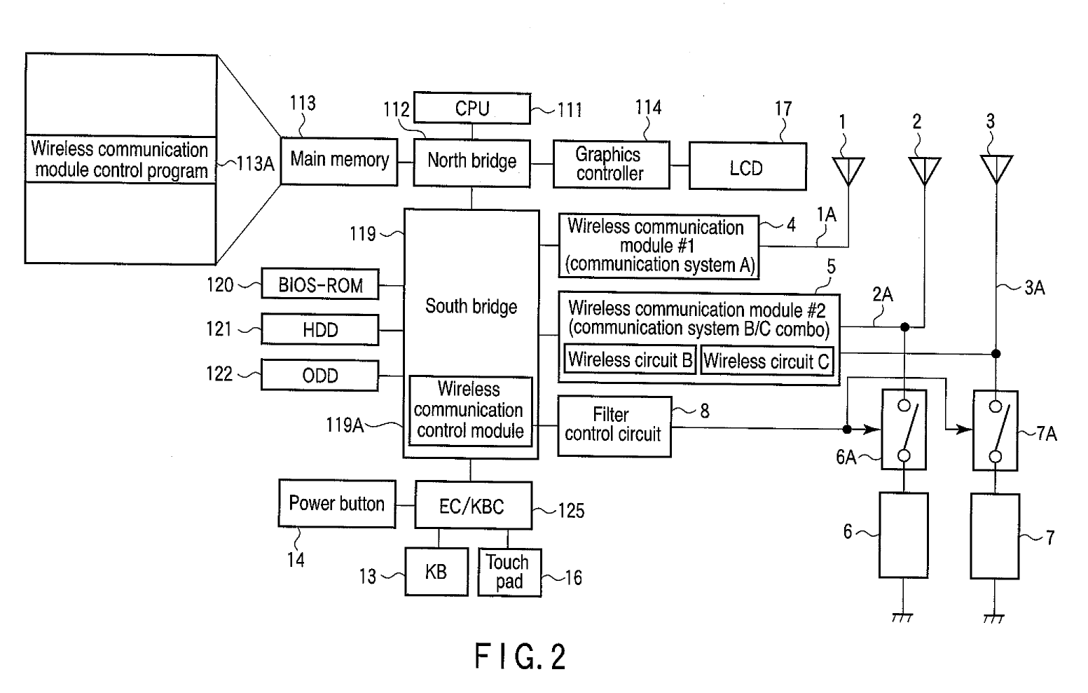

Next, referring to FIG. 2, an example of the system configuration of the computer 10 is described. In the description below, the case is assumed in which the first wireless communication module 4 is configured to execute wireless communication by a wireless communication system A, such as Bluetooth®, which uses a 2.4 GHz frequency band, and the second wireless communication module 5 is composed of a combo wireless communication module including a wireless circuit B (WLAN wireless circuit) which execute wireless communication by a wireless communication system B, such as Wireless LAN, which uses a 2.4 GHz frequency band, and a wireless circuit C (WiMAX® wireless circuit) which execute wireless communication by a wireless communication system C, such as WiMAX®, which uses a 2.5 GHz frequency band. In the combo wireless communication module, only one of the wireless circuit B (WLAN wireless circuit) and the wireless circuit C (WiMAX® wireless circuit) may be operated, or both the wireless circuit B (WLAN wireless circuit) and the wireless circuit C (WiMAX® wireless circuit) may be operated at the same time.

The computer 10 comprises a CPU 111, a north bridge 112, a main memory 113, a graphics controller 114, a south bridge 119, a BIOS-ROM 120, a hard disk drive (HDD) 121, an optical disc drive (ODD) 122, an embedded controller/keyboard controller IC (EC/KBC) 125, first wireless communication module 4, second wireless communication module 5, filter circuits 6 and 7, switch circuits 6A and 7A, and filter control circuit 8.

The CPU 111 is a processor which controls the operation of the computer 10. The CPU 111 executes an operating system (OS), various utility programs and various application programs, which are loaded from the hard disk drive (HDD) 121 into the main memory 113. The utility programs include a wireless communication module control program 113A. The wireless communication module control program 113A sets each of the filter circuits 6 and 7 in an ON state or OFF state in accordance with the combination of the operation states of the first wireless communication module 4 and second wireless communication module 5. The CPU 111 also executes a system BIOS (Basic Input/Output System) that is stored in the BIOS-ROM 120. The system BIOS is a program for hardware control.

The north bridge 112 is a bridge device which connects a local bus of the CPU 111 and the south bridge 119. In addition, the north bridge 112 has a function of communicating with the graphics controller 114.

The graphics controller 114 is a display controller which controls the LCD 17 that is used as a display monitor of the computer 10. The south bridge 119 is a bridge device which controls various I/O devices.

The first wireless communication module 4 is connected to the south bridge 119 via a bus such as a USB. In addition, the second wireless communication module 5 is connected to the south bridge 119 via a bus such as a PCI Express bus. The first wireless communication module 4 is coupled to the antenna 1 via the feeder line 1A. The antenna 1 is configured to cover the band (2.4 to 2.5 GHz) of Bluetooth® (hereinafter also referred to as “BT”).

The second wireless communication module 5 is coupled to the antenna 2 via the feeder line 2A and is also connected to the antenna 3 via the feeder line 3A. Each of the antennas 2 and 3 covers the band of 2.4 to 2.7 GHz, thereby to share the frequency band (2.4 to 2.5 GHz) of Wireless LAN and the frequency band (2.5 to 2.7 GHz) of WiMAX®.

The filter circuit 6, which is equipped with a switch, is connected to the feeder line 2A. Specifically, the filter circuit 6 is connected to the feeder line 2A via the switch circuit 6A. The switch circuit 6A is a switch (RF switch) for turning on/off the filter circuit 6. When the switch circuit 6A is turned on, the filter circuit 6 is connected to the feeder line 2A, and thereby the filter circuit 6 is set in the ON state (operative state). An equivalent circuit in this case is a circuit in which the filter circuit 6 is inserted in the feeder line 2A. When the switch circuit 6A is turned off, the filter circuit 6 is disconnected from the feeder line 2A, and the filter circuit 6 is set in the OFF state (inoperative state).

Similarly, the filter circuit 7, which is equipped with a switch, is connected to the feeder line 3A. Specifically, the filter circuit 7 is connected to the feeder line 3A via the switch circuit 7A. The switch circuit 7A is a switch (RF switch) for turning on/off the filter circuit 7. When the switch circuit 7A is turned on, the filter circuit 7 is connected to the feeder line 3A, and thereby the filter circuit 7 is set in the ON state (operative state). An equivalent circuit in this case is a circuit in which the filter circuit 7 is inserted in the feeder line 3A. When the switch circuit 7A is turned off, the filter circuit 7 is disconnected from the feeder line 3A, and the filter circuit 7 is set in the OFF state (inoperative state).

Under the control of a wireless communication control module 119A, the filter control circuit 8 switches the filter circuit 6, 7 between the ON state and OFF state by using the switch circuit 6A, 7A. The wireless communication control module 119A controls the first wireless communication module 4 (BT wireless circuit) 4, the wireless circuit B (WLAN wireless circuit) of the second wireless communication module 5, and the wireless circuit C (WiMAX® wireless circuit) of the second wireless communication module 5, and also controls the filter control circuit 8. Specifically, the first wireless communication module 4 (BT wireless circuit) 4 and the second wireless communication module 5 (WiMAX® wireless circuit and WLAN wireless circuit) are controlled by signals from the wireless communication control module 119A, and the ON/OFF of each of the switch circuits 6A and 7A is controlled in accordance with the combination of wireless circuits which are operated at the same time. Furthermore, the wireless communication control module 119A has a function of reducing the transmission power of the first wireless communication module 4 (BT wireless circuit) by about 10 dB.

The EC/KBC 125 is a one-chip microcomputer in which an embedded controller for power management and a keyboard controller for controlling the keyboard (KB) 13 and touch pad 16 are integrated. The EC/KBC 125 has a function of powering on/off the computer 10 in accordance with the user's operation of the power button 14.

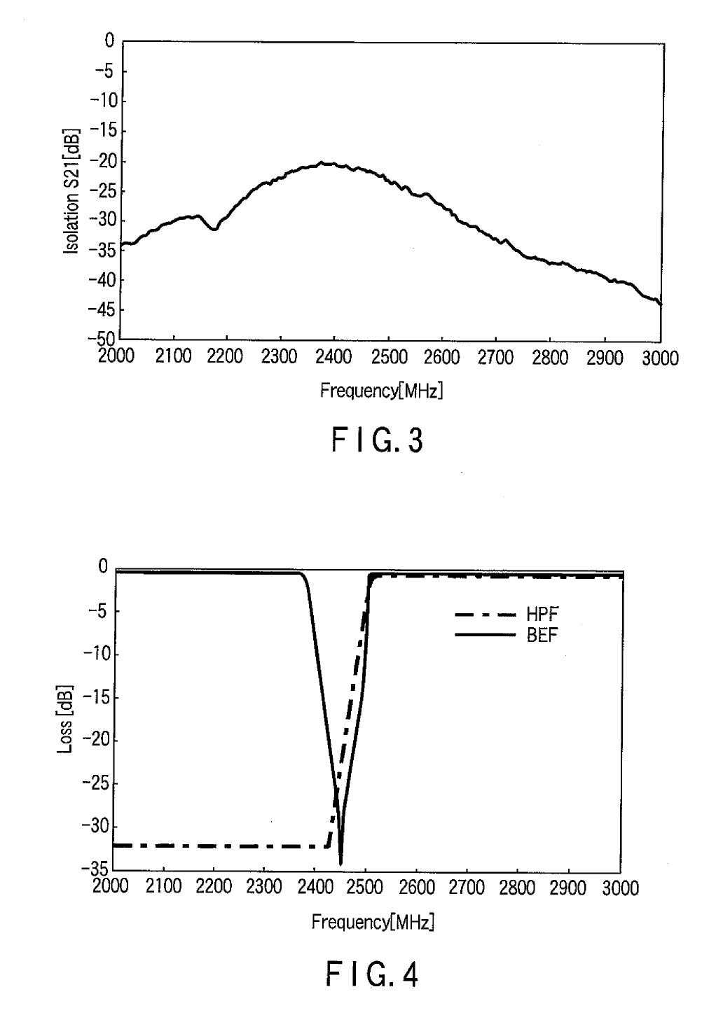

FIG. 3 shows an example of isolation characteristics between the Bluetooth® antenna (antenna 1) and Wireless LAN/WiMAX® antenna (antenna 2, 3). The abscissa in FIG. 3 indicates a frequency, and the ordinate in FIG. 3 indicates an isolation level (isolation S21[dB]).

As has been described above, the Wireless LAN/WiMAX® antenna (antenna 2, 3) covers the band of 2.4 to 2.7 GHz. Thus, when the Bluetooth® antenna (antenna 1) and the Wireless LAN/WiMAX® antenna (antenna 2, 3) are disposed within the display unit 12, as shown in FIG. 1, it is possible that only about −20 dB of the isolation level of the 2.5 GHz band could be obtained, as shown in FIG. 3. In general, a recommended value of the isolation level between the antennas of different wireless communication systems is −30 dB or less.

In particular, a problem of interference occurs when the WiMAX® wireless circuit and Bluetooth® wireless circuit (BT wireless circuit) are used in combination at the same time. The transmission power of the Bluetooth® wireless circuit, i.e. the first wireless communication module 4, is 0 dBm. If the isolation level is −20 dB, a Bluetooth® signal of about −20 dBm is input to the second wireless communication module 5 (WiMAX® wireless circuit and WLAN wireless circuit). Such large power of −20 dBm is input to the second wireless communication module 5. Thus, if the reception signal level (RSSI value) of the WiMAX® wireless circuit is low, the throughput of the WiMAX® wireless circuit would lower to 1 Mbps or less. For example, in the weak electric field environment in which the RSSI value is −55 dBm or less, the WiMAX® wireless circuit is unable to execute communication.

The BT wireless circuit usually has an AFH (Adaptive Frequency Hopping) function as a function for avoiding interference with Wireless LAN. The AFH function is a function for executing frequency hopping by avoiding channels which is being used by Wireless LAN. Accordingly, in the combination between the WLAN wireless circuit and BT wireless circuit, a certain degree of resistance to interference can be secured.

In the embodiment, the filter circuits 6 and 7 having filter characteristics, as shown in FIG. 4, are used in order to reduce a throughput decrease of the WiMAX® wireless circuit due to the interference of the Bluetooth® signal. In FIG. 4, the abscissa indicates a frequency and the ordinate indicates a power loss (Loss). As each of the filter circuits 6 and 7, use may be made of a high-pass filter (HPF) which passes frequencies of 2.5 GHz or more, or a band elimination filter (BEF) which attenuates a 2.4 GHz band.

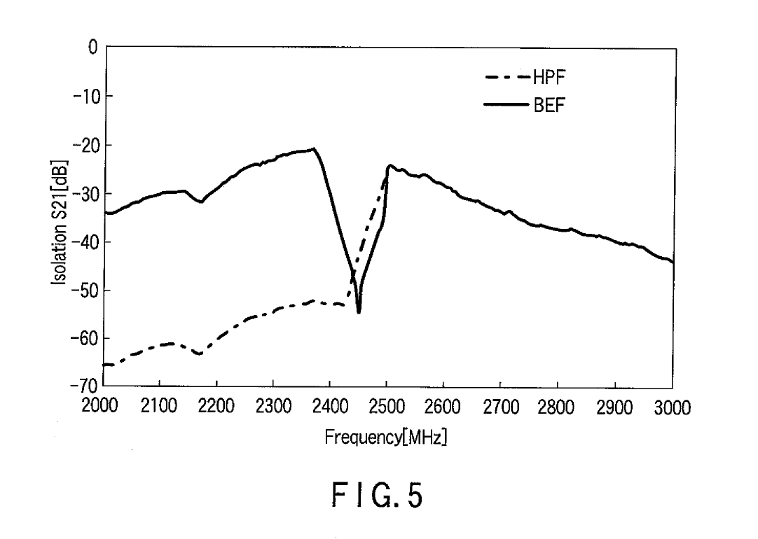

FIG. 5 shows isolation characteristics between the Bluetooth® antenna (antenna 1) and Wireless LAN/WiMAX® antenna (antenna 2, 3) at a time when the filter circuits 6 and 7 are turned on. In FIG. 5, the abscissa indicates a frequency and the ordinate indicates an isolation level (isolation S21[dB]). As is understood from FIG. 5, when the filters are connected, the signal of the 2.4 GHz band can be attenuated by about 10 dB or more. Thus, the isolation level of −30 dB or less can be secured in the 2.4 GHz band. Therefore, even when the RSSI value is, for example, −60 dBm, the WiMAX® wireless circuit can obtain the throughput characteristics of, e.g. 3 Mbps or more.

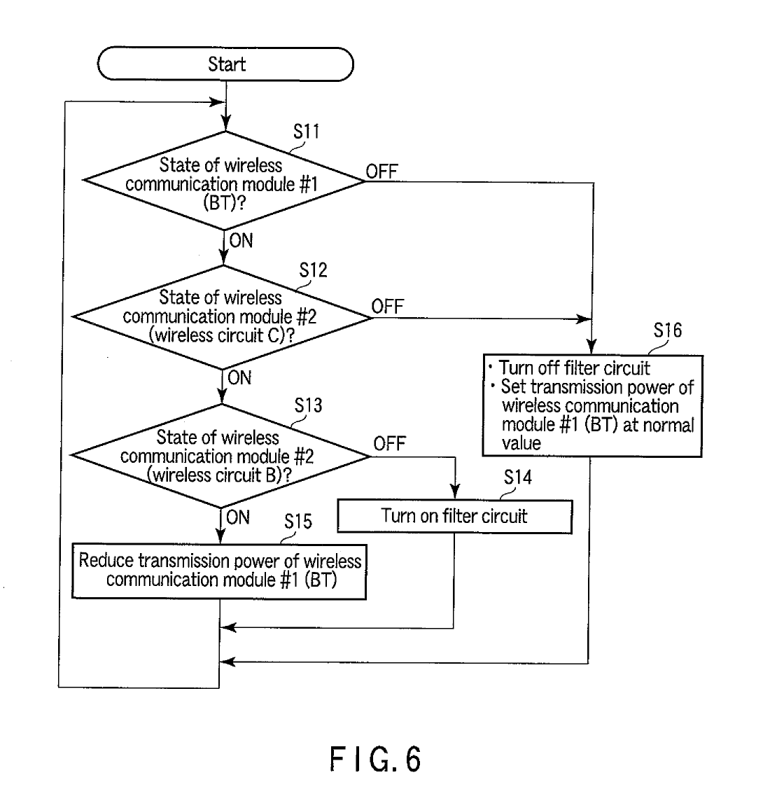

Next, referring to a flow chart of FIG. 6, a description is given of the procedure of a wireless communication module control process which is executed by the wireless communication module control program 113A.

To begin with, the outline of the wireless communication module control process is described.

When the first wireless communication module 4 (BT wireless circuit) is in the operative state (ON) and the wireless circuit C (WiMAX® wireless circuit) in the second wireless communication module 5 is in the operative state, a radio frequency interference occurs and the throughput of the wireless circuit C (WiMAX® wireless circuit) in the second wireless communication module 5 lowers. Thus, when the first wireless communication module 4 (BT wireless circuit) is in the operative state (ON) and the wireless circuit C (WiMAX® wireless circuit) in the second wireless communication module 5 is in the operative state, the wireless communication module control program 113A turns on the switch circuits 6A and 7B, thereby turning on the filter circuits 6 and 7. It is possible, therefore, to attenuate the signal of the 2.4 GHz band which is input to the second wireless communication module 5 from the antenna 1 via the antenna 2, 3.

When either the first wireless communication module 4 (BT wireless circuit) or the wireless circuit C (WiMAX® wireless circuit) in the second wireless communication module 5 is in the inoperative state, no radio frequency interference occurs. Thus, when either the first wireless communication module 4 (BT wireless circuit) or the wireless circuit C (WiMAX® wireless circuit) in the second wireless communication module 5 is in the inoperative state, the wireless communication module control program 113A turns off the switch circuits 6A and 7B, thereby turning off the filter circuits 6 and 7.

As has been described with reference to FIG. 2, as the second wireless communication module 5, use may be made of the combo wireless communication module including the wireless circuit C (WiMAX® wireless circuit) and the wireless circuit B (WLAN wireless circuit). In this case, the filter circuits 6 and 7 may be turned on, on condition that the first wireless communication module 4 (BT wireless circuit) is in the operative state (ON), the wireless circuit C (WiMAX® wireless circuit) in the second wireless communication module 5 is in the operative state (ON) and the wireless circuit B (WLAN wireless circuit) in the second wireless communication module 5 is in the inoperative state. If all the first wireless communication module 4 (BT wireless circuit), the wireless circuit C (WiMAX® wireless circuit) in the second wireless communication module 5 and the wireless circuit B (WLAN wireless circuit) in the second wireless communication module 5 are in the operative state (ON), a process of lowering the transmission power of the first wireless communication module 4 (BT wireless circuit) is executed by the wireless communication module control program 113A.

In this manner, the wireless communication module control program 113A monitors the states of the BT wireless circuit, the wireless circuit C (WiMAX® wireless circuit) and the wireless circuit B (WLAN wireless circuit), and executes the process of setting the filter circuit 6, 7 in the ON state or OFF state or the process of controlling the transmission power of the BT wireless circuit, in accordance with the combination of the states of the BT wireless circuit, the wireless circuit C (WiMAX® wireless circuit) and the wireless circuit B (WLAN wireless circuit).

Next, an example of the procedure of the wireless communication module control process is described.

To start with, the wireless communication module control program 113A determines whether the first wireless communication module 4 (BT wireless circuit) is in the operative state (ON) or in the inoperative state (OFF) (step S11). If the first wireless communication module 4 (BT wireless circuit) is in the inoperative state (OFF), that is, if the first wireless communication module 4 (BT wireless circuit) is not in use, the wireless communication module control program 113A turns off the switch circuits 6A and 7B, thereby turning off the filter circuits 6 and 7 (step S16). In step S16, a process of setting the transmission power of the first wireless communication module 4 (BT wireless circuit) at a normal value (e.g. 0 dBm) is also executed.

If the first wireless communication module 4 (BT wireless circuit) is in the operative state (ON), that is, if the first wireless communication module 4 (BT wireless circuit) is in use, the wireless communication module control program 113A determines whether the wireless circuit C (WiMAX® wireless circuit) in the second wireless communication module 5 is in the operative state (ON) or in the inoperative state (OFF) (step S12).

If the wireless circuit C (WiMAX® wireless circuit) is in the inoperative state (OFF), no interference occurs between the BT wireless circuit and the wireless circuit C (WiMAX® wireless circuit). Thus, the wireless communication module control program 113A turns off the switch circuits 6A and 7B, thereby turning off the filter circuits 6 and 7 (step S16). In step S16, as described above, the process of setting the transmission power of the first wireless communication module 4 (BT wireless circuit) at a normal value (e.g. 0 dBm) is also executed.

If the wireless circuit C (WiMAX® wireless circuit) is in the operative state (ON), that is, if both the BT wireless circuit and the wireless circuit C (WiMAX® wireless circuit) are in operation, the wireless communication module control program 113A determines whether the wireless circuit B (WLAN wireless circuit) in the second wireless communication module 5 is in the operative state (ON) or in the inoperative state (OFF) (step S13). If the wireless circuit B (WLAN wireless circuit) is in the inoperative state (OFF), the wireless communication module control program 113A turns on the switch circuits 6A and 6B and thus turns on the filter circuits 6 and 7, in order to prevent interference between the BT wireless circuit and the wireless circuit C (WiMAX® wireless circuit) (step S14). It is possible, therefore, to attenuate the signal of the 2.4 GHz band, which is input to the second wireless communication module 5 from each of the antennas 2 and 3, by about 10 dB, and to prevent interference between the BT wireless circuit and the wireless circuit C (WiMAX® wireless circuit). On the other hand, if the wireless circuit B (WLAN wireless circuit) is in the operative state (ON), the wireless communication module control program 113A reduces the transmission power of the BT wireless circuit by about 10 dB, while keeping the filter circuits 6 and 7 in the OFF state, in order to prevent interference between the BT wireless circuit and the wireless circuit C (WiMAX® wireless circuit) (step S15). In step S15, the transmission power of the BT wireless circuit is lowered from the normal value (0 dBm) to −10 dBm. Thereby, it is possible to prevent the interference between the BT wireless circuit and the wireless circuit C (WiMAX® wireless circuit). However, the range of communication of the Bluetooth® wireless circuit is decreased to about 3 m or less in radius.

As has been described above, according to the present embodiment, the filter circuits 6 and 7 for attenuating the signal of the frequency band, which is used by the first wireless communication module 4, are connected between the second wireless communication module 5 and the antennas 2 and 3. By turning on the filter circuits 6 and 7 as described, it is possible to reduce the degradation in throughput characteristics of the second wireless communication module 5 due to the interference between the first wireless communication module 4 and the second wireless communication module 5.

The second wireless communication module 5 is not necessarily the combo wireless communication module. For example, the second wireless communication module 5 may be realized as a wireless communication module including the wireless circuit C (WiMAX® wireless circuit), and the wireless circuit B (WLAN wireless circuit) may be realized as a third wireless communication module which is coupled to the antennas 2 and 3. The antennas 2 and 3 are commonly used by the second wireless communication module 5 and the third wireless communication module. Specifically, each of the second wireless communication module 5 and the third wireless communication module is connected to the antenna 2 via the feeder line 2A and is connected to the antenna 3 via the feeder line 3A.

In the embodiment, the case in which the two antennas 2 and 3 are coupled to the second wireless communication module 5 has been described by way of example. However, only one antenna may be coupled to the second wireless communication module 5.

Besides, in the embodiment, the description has been given of the example in which the filter circuits 6 and 7 are controlled in accordance with the combination of the states of the first wireless communication module 4 and second wireless communication module 5. Alternatively, the filter circuits 6 and 7 may be turned on when the first wireless communication module 4 is in the operative state, and the filter circuits 6 and 7 may be turned off when the first wireless communication module 4 is in the inoperative state.

The various modules of the systems described herein can be implemented as software applications, hardware and/or software modules, or components on one or more computers, such as servers. While the various modules are illustrated separately, they may share some or all of the same underlying logic or code.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An information processing apparatus comprising:
a first wireless communication module configured to wirelessly transmit and wirelessly receive signals using a first frequency band;
a first antenna coupled to the first wireless communication module;
a second wireless communication module configured to wirelessly transmit and wirelessly receive signals using a second frequency band;
a second antenna coupled to the second wireless communication module;
a filter circuit connected between the second wireless communication module and the second antenna and configured to attenuate a signal belonging to the first frequency band; and
a control module configured to turn on the filter circuit when the first wireless communication module is in an operative state.

2. The information processing apparatus of claim 1, further comprising a third wireless communication module coupled to the second antenna and configured to wirelessly transmit and wirelessly receive signals using the first frequency band,
wherein the second antenna is configured to cover the first frequency band and the second frequency band.

3. The information processing apparatus of claim 1, further comprising a third wireless communication module coupled to the second antenna and configured to wirelessly transmit and wirelessly receive signals by using the first frequency band,
wherein the second wireless communication module and the third wireless communication module are coupled to the second antenna via a feeder line,
wherein the second antenna is configured to cover the first frequency band and the second frequency band, and
wherein the filter circuit is connected to the feeder line.

4. The information processing apparatus of claim 1, wherein the control module is configured to turn on the filter circuit when the first wireless communication module is in the operative state and to turn off the filter circuit when the first wireless communication module is in an inoperative state.

5. The information processing apparatus of claim 1, further comprising:
a main body including the first wireless communication module and the second wireless communication module; and
a display unit rotatably attached to the main body,
wherein the first antenna and the second antenna are included in the display unit, and the filter circuit is included in the main body.

6. An information processing apparatus comprising:
a first wireless communication module configured to wirelessly transmit and wirelessly receive signals using a first frequency band;
a first antenna coupled to the first wireless communication module via a first feeder line and configured to cover the first frequency band;
a combo wireless communication module including a first wireless circuit and a second wireless circuit, the first wireless circuit configured to wirelessly transmit and wirelessly receive signals using a second frequency band, and the second wireless circuit configured to wirelessly transmit and wirelessly receive signals using the first frequency band;
a second antenna coupled to the second wireless communication module via a second feeder line and configured to cover the first frequency band and the second frequency band;
a filter circuit connected to the second feeder line and configured to attenuate a signal belonging to the first frequency band; and
a control module configured to turn on the filter circuit when the first wireless communication module and the first wireless circuit are in an operative state and the second wireless circuit is in an inoperative state.

7. The information processing apparatus of claim 6, wherein the control module is further configured to turn off the filter circuit when either the first wireless communication module or the first wireless circuit is in the inoperative state.

8. The information processing apparatus of claim 6, wherein the control module is configured to reduce transmission power of the first wireless communication module, while keeping the filter circuit in an off state, when the first wireless communication module, the first wireless circuit and the second wireless circuit are in the operative state.

9. The information processing apparatus of claim 6, further comprising:
a main body including the first wireless communication module and the combo wireless communication module; and
a display unit rotatably attached to the main body,
wherein the first antenna and the second antenna are included in the display unit, and the filter circuit is included in the main body.
